(19) United States
(12) Patent Application Publication
(10) Pub. No.: US 2009/0029039 A1
(43) Pub. Date: Jan. 29, 2009

(54) Method of manufacturing membrane electrode assembly

(75) Inventors: Masao Okumura, Toyota-shi (JP); Masanori Aimu, Toyota-shi (JP); Tatsuya Hatanaka, Aichi-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/219,108

(22) Filed: Jul. 16, 2008

(30) Foreign Application Priority Data
Jul. 23, 2007 (JP) 2007-190596

(51) Int. Cl. B05D 5/06

(52) U.S. Cl. 427/115

(57) ABSTRACT

A method of manufacturing a membrane electrode assembly for a fuel cell, in which a catalyst layer is disposed between an electrolyte membrane and a gas diffusion layer, includes producing a catalyst powder that is used to form the catalyst layer; and forming the catalyst layer by unevenly depositing the catalyst powder on at least one of the electrolyte membrane and the gas diffusion layer.

### INCORPORATION BY REFERENCE

The disclosure of Japanese Patent Application No. 2007-190596 filed on Jul. 23, 2007, including the specification, drawings and abstract is incorporated herein by reference in its entirety.

### BACKGROUND OF THE INVENTION

1. Field of the Invention

The invention relates to a method of manufacturing a membrane electrode assembly for a fuel cell.

2. Description of the Related Art

A fuel cell may include a membrane electrode assembly (hereinafter referred to as “MEA”) that includes an electrolyte membrane, a catalyst layer formed on each side of the electrolyte membrane, and a gas diffusion layer formed on the catalyst layer. In the catalyst layer, an electrochemical reaction is caused using fuel gas and oxidation gas (reaction gas) supplied to the catalyst layer via the gas diffusion layer. Thus, Japanese Patent Application Publication No. 3-167752 (JP-A-3-167752) proposes a MEA manufacturing method in which the catalyst layer is made uneven to increase the area where the catalyst layer contacts the gas diffusion layer so that the electrochemical reaction is promoted.

In the MEA manufacturing method described in the publication No. 3-167752, a press jig, which includes a female die with an uneven surface and a male die that is fitted to the female die, is used to make the catalyst layer uneven. A catalyst layer in a plate shape is placed on the female die, and the male die is pressed to the catalyst layer to make the catalyst layer uneven. However, in this manufacturing method, when the male die is pressed to the catalyst layer, a large force is applied to the catalyst layer, and therefore, the catalyst layer may be physically damaged. An extremely large force is applied particularly to a portion of the catalyst layer, which contacts an end of a protruding portion of the female die. Therefore, the portion of the catalyst is likely to be damaged.

### SUMMARY OF THE INVENTION

The invention provides a method of manufacturing a MEA that includes an uneven catalyst layer, which makes it possible to reduce the possibility that the catalyst layer is damaged when the catalyst layer is made uneven.

An aspect of the invention relates to a method of manufacturing a membrane electrode assembly for a fuel cell, in which a catalyst layer is disposed between an electrolyte membrane and a gas diffusion layer. The method includes producing a catalyst powder that is used to form the catalyst layer; and forming the catalyst layer by unevenly depositing the catalyst powder on at least one of the electrolyte membrane and the gas diffusion layer.

In the method of manufacturing a membrane electrode assembly, the catalyst layer is formed by unevenly deposing the catalyst powder on at least one of the electrolyte membrane and the gas diffusion layer. Therefore, it is possible to reduce the possibility that the catalyst layer is damaged when the catalyst is made uneven.

Thus, by depositing the catalyst powder through the screen, it is possible to unevenly deposit the catalyst powder on at least one of the electrolyte membrane and the gas diffusion layer.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a flowchart showing the procedure of a MEA manufacturing method according to a first embodiment;

FIG. 2 schematically shows the detailed procedure of the process in step S105 in the flowchart shown in FIG. 1;

FIGS. 3A and 3B show a screen and a mask used in step S110;

FIG. 4A schematically shows a method of forming a deposit of a catalyst powder 300 using the screen S1 shown in FIG. 3A, and FIG. 4B schematically shows a method of forming a deposit of the catalyst powder 300 using the screen S1 shown in FIG. 3A and the mask M1 shown in FIG. 3B;

FIG. 5 shows a MEA 90 formed in by the process in step S115;

FIG. 6 shows the configuration of a fuel cell including the MEA 90;

FIG. 7 shows the MEA 90 in a cross section taken along the line VI-VI in FIG. 6;

FIG. 8A schematically shows a mask M1a according to a second embodiment, and FIG. 8B schematically shows a MEA 90a formed using the mask M1a;

FIG. 9A schematically shows a mask M1b according to a third embodiment, and FIG. 9B schematically shows a MEA 90b formed using the mask M1b;

FIG. 10A schematically shows a mask M1c according to a fourth embodiment, and FIG. 10B schematically shows a MEA 90c formed using the mask M1c;

FIG. 11 shows a screen according to a fifth embodiment; and

FIG. 12 is a chart showing the I-V characteristics (“I” stands for current density, and “V” stands for voltage) of a fuel cell produced in an example and the I-V characteristics of a fuel cell produced in a comparative example.

### DETAILED DESCRIPTION OF EMBODIMENTS

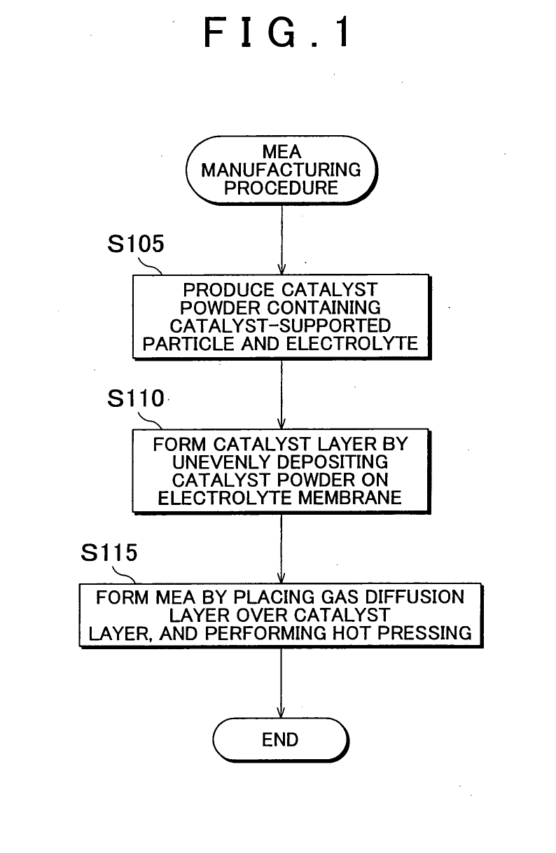

A first embodiment will be described. FIG. 1 is a flowchart showing the procedure of a MEA manufacturing method according to the first embodiment of the invention. In step S105, a composite powder (catalyst powder) in which catalyst-supported particles and an electrolyte are combined is produced as a powder used to form a catalyst layer.

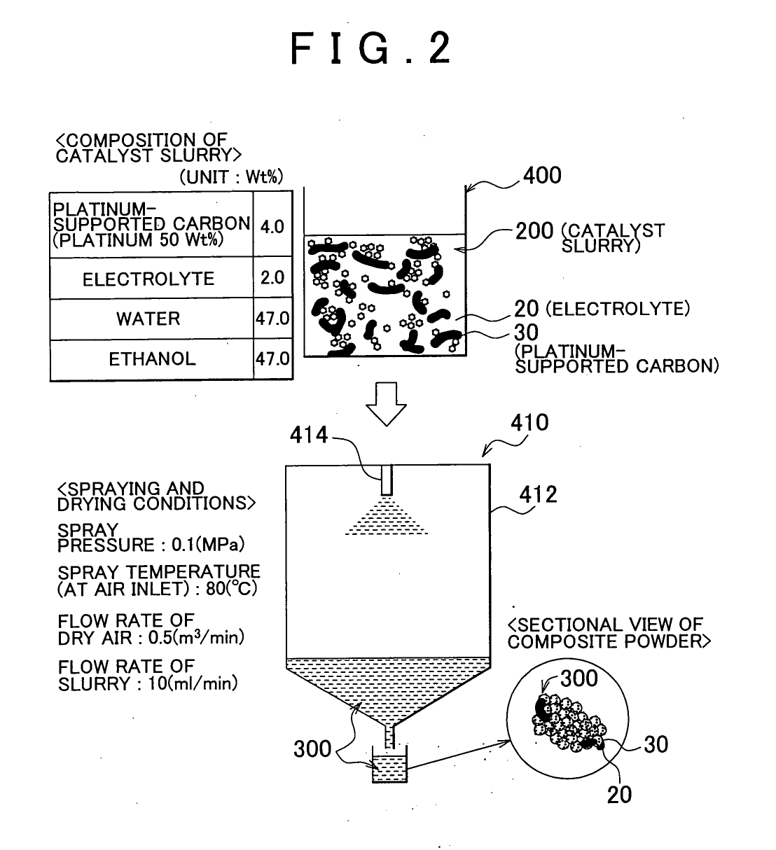

FIG. 2 schematically shows the detailed procedure of the process in step S105 in the flowchart shown in FIG. 1. In an example in FIG. 2, platinum-supported carbon 30 (platinum 50 Wt %), which functions as the catalyst-supported particles, and Nafion (registered trademark), which functions as an electrolyte 20, are added to a mixed solvent. The mixed solvent is the mixture of water and ethanol. The platinum-supported carbon 30 and Nafion are mixed and diffused in the mixed solvent, whereby a catalyst slurry 200 is obtained. Then, a catalyst powder 300 is produced by spraying and drying the catalyst slurry 200 by a spray-drying method, using a spray drier 410. More specifically, the catalyst slurry 200 is sprayed into a chamber 412 using an atomizer 414 included in the spray drier 410, and the mist of the sprayed catalyst slurry 200 is brought into contact with the dried air so that the catalyst slurry 200 is instantaneously dried, whereby the catalyst powder 300 is obtained. The catalyst powder 300 thus obtained is the composite powder of the platinum-supported carbon 30 and the electrolyte 20.

In step S110 (in the flowchart in FIG. 1), a catalyst layer is formed by unevenly depositing the catalyst powder produced in step S105 on an electrolyte membrane. More specifically, the catalyst powder 300 (shown in FIG. 2) is dropped on the electrolyte membrane through a screen and a mask by electrostatic screening so as to deposit the catalyst powder 300 on the electrolyte membrane. For example, Nafion (registered trademark) made by DuPont, Aciplex (registered trademark) made by Asahi Kasei Corporation, or Flemion (registered trademark) made by Asahi Glass Co., Ltd. may be used as the electrolyte membrane.

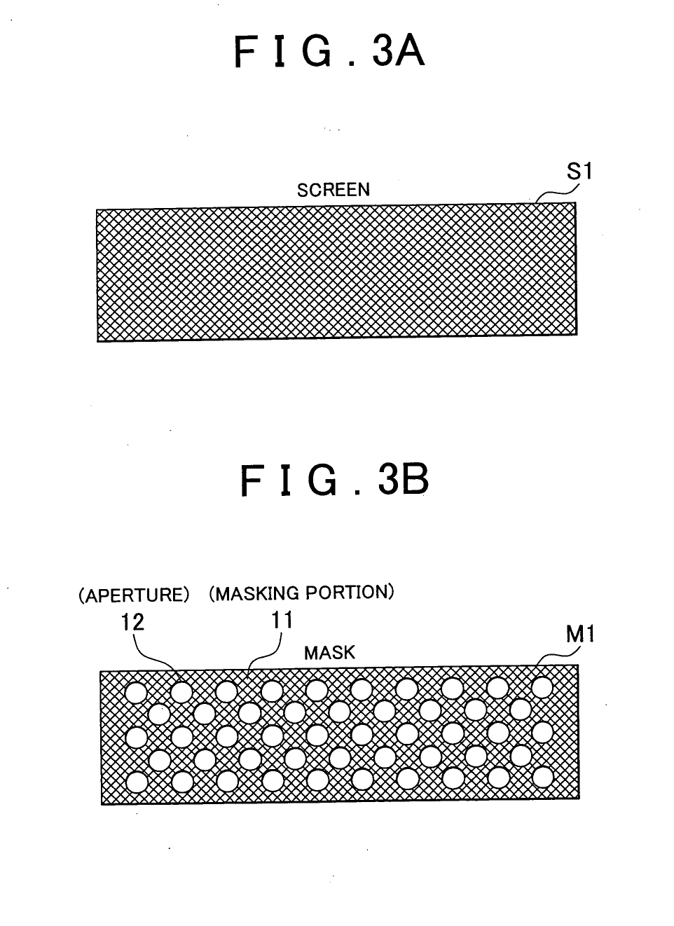

FIG. 3A shows the screen S1 used in step S110. FIG. 3A shows an area of the screen S1, through which the catalyst powder passes (hereinafter, the area through which the catalyst powder passes may be referred to as “powder-passing area”). In the screen S1, a large number of small apertures (not shown) are formed in the entire powder-passing area in a manner such that an aperture ratio is uniform in the entire powder-passing area. Synthetic fabric, such as nylon, or metallic fabric made by, for example, weaving metallic wires, such as stainless steel wires, may be used as the material for the screen S1.

FIG. 3B shows the mask M1 used in step S110. FIG. 3B shows the powder-passing area of the mask M1. A plurality of apertures 12 are disposed at constant intervals in the mask M1. The apertures have the same size. The aperture ratio is 50%. A portion other than the apertures 12 is a masking portion 11. Because no aperture is formed in the masking portion 11, the catalyst powder does not pass through the masking portion 11. For example, a synthetic-resin plate member with apertures may be used as the mask M1.

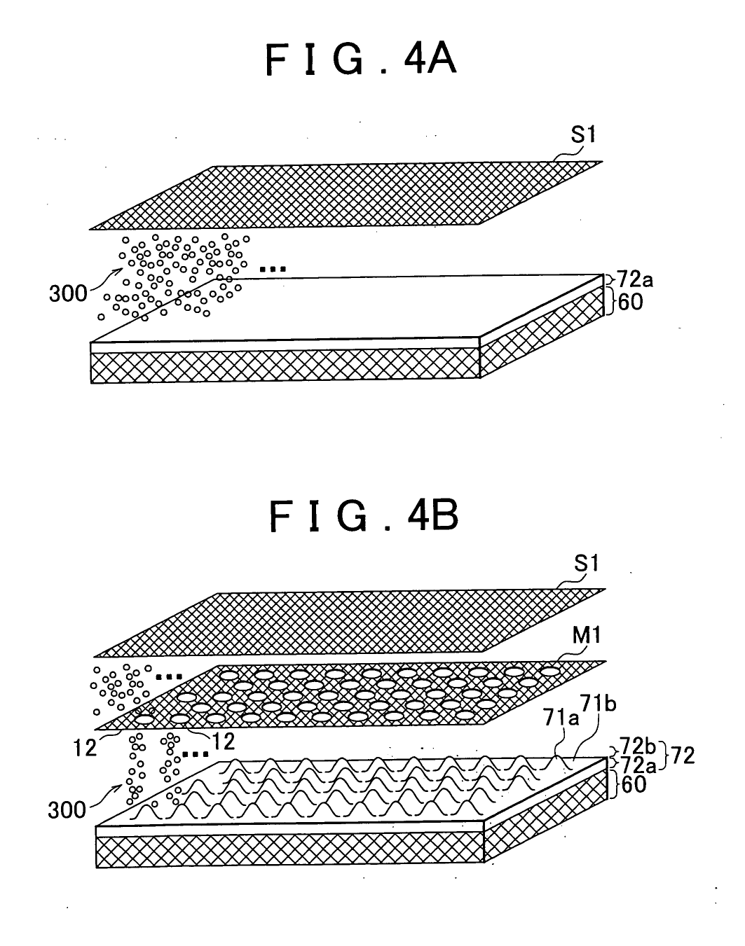

FIG. 4A schematically shows a method of forming a deposit of the catalyst powder 300 using the screen S1 shown in FIG. 3A. Hereinafter, a case where the catalyst powder 300 is deposited on the surface of the electrolyte membrane 60 in a cathode side will be described. In step S110 (in the flowchart in FIG. 1), first, the catalyst powder 300 is deposited on the surface of the electrolyte membrane 60 in the cathode side by electrostatic screening using the screen S1. More specifically, high voltage is applied to the screen S1, which is positioned away from the electrolyte membrane 60, to produce an electrostatic field between the screen S1 and the electrolyte membrane 60, and the catalyst powder 300 is dropped toward the screen S1. Because the electrostatic field is produced, the catalyst powder 300 is dropped on the surface of the electrolyte membrane 60 that functions as a counter electrode, through the screen S1. In this way, a layer 72a of the catalyst powder 300, which has a substantially uniform thickness, is formed on the electrolyte membrane 60.

FIG. 4B schematically shows a method of forming a deposit of the catalyst powder 300 using the screen S1 shown in FIG. 3A and the mask M1 shown in FIG. 3B. After the layer 72a shown in FIG. 4A is formed on the electrolyte membrane 60, further, the catalyst powder 300 is partially deposited on the layer 72a by electrostatic screening using the screen S1 (shown in FIG. 3A) and the mask M1 (shown in FIG. 3B). More specifically, the mask M1 (shown in FIG. 3B) is disposed between the screen S1 and the electrolyte membrane 60 with the layer 72a, and then, the catalyst powder 300 is dropped from above the screen S1 toward the electrolyte membrane 60 (i.e., toward the layer 72a) by electrostatic screening. Thus, the catalyst powder 300 is dropped only through the apertures 12 of the mask M1. As a result, a layer 72b of the catalyst powder 300 is formed on the layer 72a. In the layer 72b, substantially cone-shaped deposits of the catalyst powder 300 are formed at positions corresponding to the apertures 12. Thus, a catalyst layer (cathode-side catalyst layer) 72 composed of the layers 72a and 72b is formed on the electrolyte membrane 60. The cathode-side catalyst layer 72 has a non-uniform thickness. Hereinafter, the cone-shaped deposits of the catalyst powder 300 in the cathode-side catalyst layer 72 are referred to as catalyst protruding portions 71a and a portion other than the catalyst protruding portions 71a is referred to as a catalyst recessed portion 71b. In other words, the catalyst protruding portion 71a is a portion in which a deposition amount of the catalyst powder 300 is equal to or larger than an average deposition amount of the catalyst powder 300 in the cathode-side catalyst layer 72. The catalyst recessed portion 71b is a portion in which the deposition amount of the catalyst powder 300 is smaller than the average deposition amount of the catalyst powder 300 in the cathode-side catalyst layer 72. In an anode side as well, a catalyst layer (anode-side catalyst layer) is formed in the same manner as that in which the cathode-side catalyst layer 72 is formed. The above-described screen S1 and the mask M1 may be regarded as the screen according to the invention.

In step S115 (in the flowchart shown in FIG. 1), a gas diffusion layer that is prepared in advance is placed over the catalyst layer formed in step S110, and hot pressing is performed. Thus, the MEA is formed.

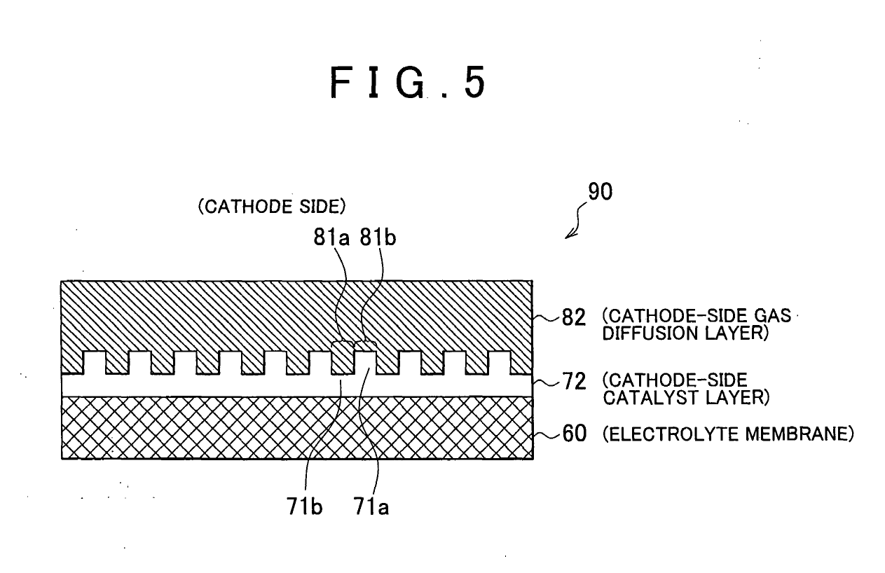

FIG. 5 shows the MEA 90 formed by the process in step S115. FIG. 5 shows only the cathode side of the MEA 90. The cathode-side gas diffusion layer 82 used in the embodiment is formed by applying water-repellent paste on carbon paper that functions as a base material. The water-repellent past contains fluorine resin (for example, polytetrafluoroethylene (PTFE)) that functions as a water-repellent material. The cathode-side gas diffusion layer 82 includes a diffusion protruding portion 81a and diffusion recessed portions 81b. That is, the cathode-side gas diffusion layer 82 is an uneven layer. For example, the uneven cathode-side gas diffusion layer 82 is formed as follows. The water-repellent paste is applied on the carbon paper that functions as the base material in a manner such that the water-repellent paste has a predetermined uniform thickness. Then, after portions that serve as the diffusion recessed portions 81b are covered with the mask, the water-repellent paste is further applied, and then, the mask is removed. Thus, the uneven cathode-side gas diffusion layer 82 is formed.

When the cathode-side gas diffusion layer 82 is placed over the cathode-side catalyst layer 72, the diffusion protruding portion 81a in the cathode-side gas diffusion layer 82 faces the catalyst recessed portion 71b in the cathode-side catalyst layer 72. The diffusion recessed portions 81b face the catalyst protruding portions 71a in the cathode-side catalyst layer 72. Accordingly, when the cathode-side gas diffusion layer 82 is placed over the cathode-side catalyst layer 72, the cathode protruding portions 71a and the cathode recessed portion 71b in the cathode-side catalyst layer 72 engage with the diffusion recessed portions 81b and the diffusion protruding portion 81a in the cathode-side gas diffusion layer 82, respectively. In the anode side as well, the gas diffusion layer is formed on the catalyst layer in the same manner as that in which the cathode-side gas diffusion layer 82 is formed.

In the MEA manufacturing method described above, the uneven catalyst layer is formed by deposing the catalyst powder 300 so that the catalyst layer has a non-uniform thickness. Therefore, it is possible to reduce the possibility that the catalyst layer is damaged when the catalyst layer is made uneven.

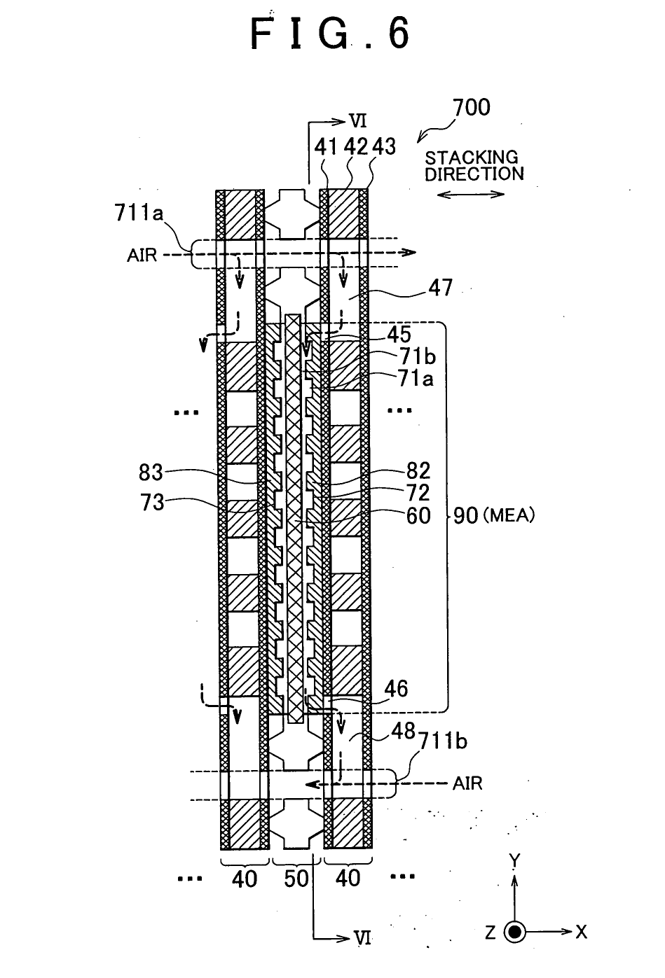

FIG. 6 shows the configuration of a fuel cell that includes the MEA 90. A plate 50 including the MEA 90 (hereinafter, referred to as “MEA plate 50”) is produced using the MEA 90 produced in the above-described manner. A fuel cell 700 is formed by alternately stacking the MEA plates 50 and separators 40. The separator 40 is a three-layered separator that includes three metal plates. More specifically, the separator 40 includes a cathode-side plate 41, an anode-side plate 43, and an intermediate plate 42 disposed between the cathode-side plate 41 and the anode-side plate 43. Holes are formed at the same positions in each of the plates 41 to 43 and the MEA plate 50. By stacking the MEA plates 50 with the holes and the separators 40 with the holes, an oxidation gas supply manifold 711a and an oxidation gas discharge manifold 711b are formed. In the cathode-side plate 41, gas supply holes 45 that are adjacent to the cathode-side gas diffusion layer 82 are formed at a position relatively close to the oxidation gas supply manifold 711a. Similarly, gas discharge holes 46 that are adjacent to the cathode-side gas diffusion layer 82 are formed at positions relatively close to the oxidation gas discharge manifold 711b. An oxidation gas supply passage 47 is formed in the intermediate plate 42. The oxidation gas supply passage 47 is connected to the oxidation gas supply manifold 711a, and leads to the gas supply holes 45. In the intermediate plate 42, an oxidation gas discharge passage 48 is also formed. The oxidation gas discharge passage 48 is connected to the oxidation gas discharge manifold 711b, and leads to the gas discharge holes 46.

Air, which functions as an oxidant, is supplied through the oxidation gas supply manifold 711a, and flows into the oxidation gas supply passage 47 in the intermediate plate 42. Then, the air is supplied to the cathode-side gas diffusion layer 82 through the gas supply holes 45. The air supplied to the cathode-side gas diffusion layer 82 is diffused in the MEA 90, and used in an electrochemical reaction in the cathode-side catalyst layer 72. Air that is not used in the electrochemical reaction is discharged to the oxidation gas discharge manifold 711b through the gas discharge holes 46 and the oxidation gas discharge passage 48. At this time, water produced by the electrochemical reaction is discharged along with the air.

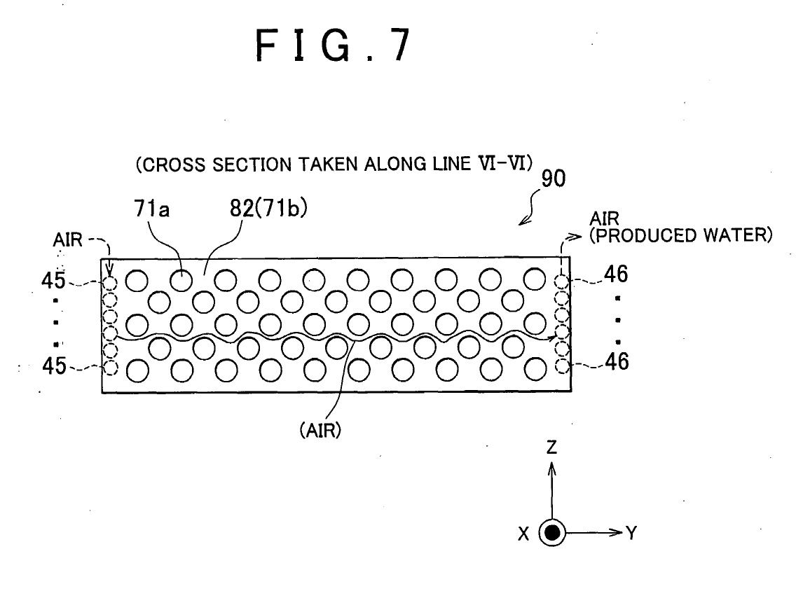

FIG. 7 is a diagram showing a cross section of the MEA 90 taken along the line VI-VI in FIG. 6. In the MEA 90, the cathode-side gas diffusion layer 82 continuously extends from a position corresponding to the gas supply holes 45 to a position corresponding to the gas discharge holes 46, in the cross section of the MEA 90 taken at a position near a border between the cathode-side gas diffusion layer 82 and the cathode-side catalyst layer 72. Thus, in the MEA 90, air, which functions as the oxidation gas, is diffused also in the area near the border between the cathode-side gas diffusion layer 82 and the cathode-side catalyst layer 72. Therefore, the air is diffused in the entire MEA 90. The anode-side has the configuration similar to the configuration of the cathode-side. Thus, fuel gas is diffused in the entire MEA 90.

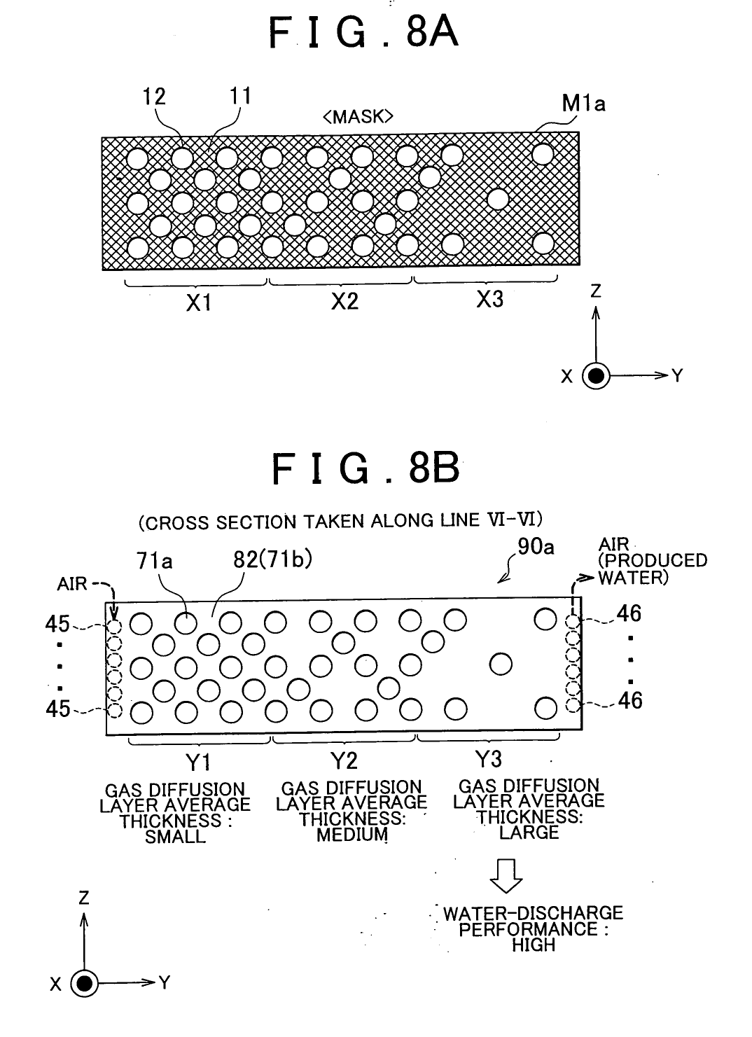

A second embodiment will be described. FIG. 8A shows a mask M1a in the second embodiment. FIG. 8B schematically shows a MEA 90a configured using the mask M1a shown in FIG. 8A. FIG. 8B shows a cross section of the MEA 90a when used to form the fuel cell, taken along the line VI-VI (refer to FIG. 6), like FIG. 7. In the first embodiment, the plurality of apertures 12 of the mask M1 (shown in FIG. 3B) are disposed at constant intervals. The average aperture ratio is substantially the same in any region. However, in the mask M1a in the second embodiment, the plurality of apertures 12 are not disposed at constant intervals. The average aperture ratio varies depending on the region in the mask M1a. Other portions of the configuration in the second embodiment are the same as those in the first embodiment.

More specifically, as shown in FIG. 8A, the number of apertures 12 per unit area in a region X1 is larger than that in a region X2, and the number of apertures 12 per unit area in a region X3 is smaller than that in the region X2. Accordingly, the average aperture ratio is high (for example, 70%) in the region X1, medium (for example, 50%) in the region X2, and low (for example, 30%) in the region X3. When the mask Mla with this configuration is used, it is possible to obtain the same advantageous effects as those obtained in the first embodiment.

When the MEA 90a (shown in FIG. 8B) is manufactured using the cathode-side catalyst layer 72 formed using the mask M1a, the number of the catalyst protruding portions 71a per unit area varies depending on the region in the cathode-side catalyst layer 72. More specifically, the number of the catalyst protruding portions 71a per unit area is large in a region Y1 close to the gas supply holes 45, medium in a region Y2, and small in a region Y3 close to the gas discharge holes 46. In this case, in a plane view of the cathode-side catalyst layer 72 perpendicular to a direction in which the catalyst powder is disposed (i.e., the plane perpendicular to the X axis), a proportion of the catalyst recessed portion 71b in the unit area is low in the region Y1, medium in the region Y2, and high in the region Y3. Accordingly, when the cathode-side gas diffusion layer 82 is placed over the cathode-side catalyst layer 72, the average thickness of the cathode-side gas diffusion layer 82 is small in the region Y1, medium in the region Y2, and large in the region Y3. Water produced by the electrochemical reaction in the cathode-side catalyst layer 72 is concentrated in the region Y3 close to the gas discharge holes 46, and therefore, flooding is likely to occur in the region Y3. However, because the average thickness of the cathode-side gas diffusion layer 82 is relatively large in the region Y3, water-discharge performance in the region Y is relatively high, and thus, occurrence of flooding is suppressed.

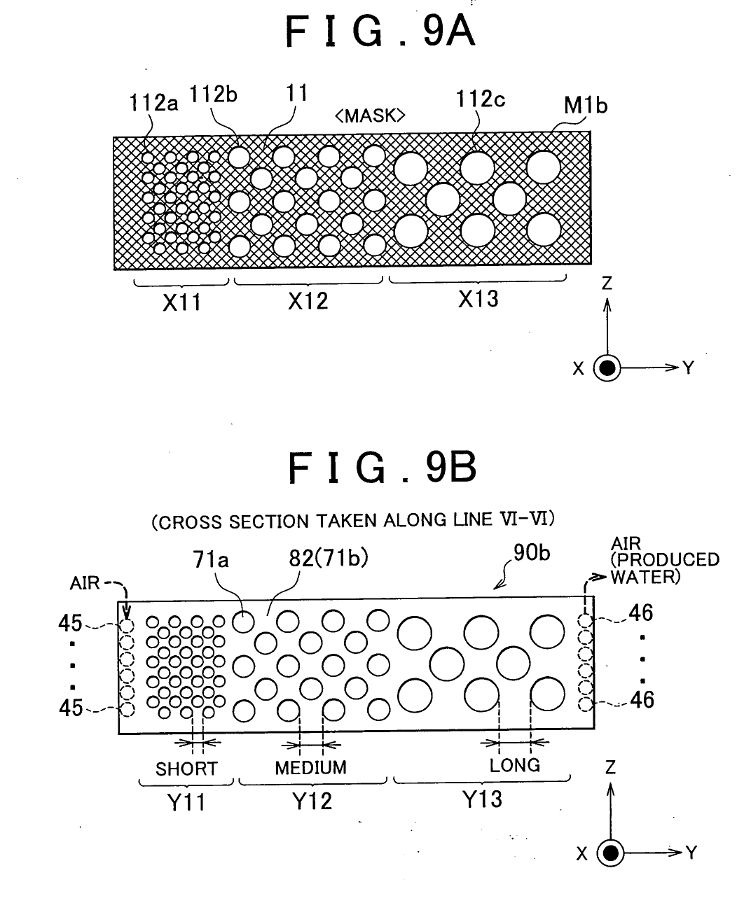

A third embodiment will be described. FIG. 9A shows a mask M1b in the third embodiment. FIG. 9B schematically shows a MEA 90b configured using the mask M1b shown in FIG. 9A. FIG. 9B shows a cross section of the MEA 90b when used to form the fuel cell, taken along the line VI-VI (refer to FIG. 6), like FIG. 7. In the first embodiment, the plurality of apertures 12 of the mask M1 (shown in FIG. 3B) have the same size. However, in the mask M1b in the third embodiment, the size of the aperture 12 varies depending on the region in the mask M1b. Other portions of the configuration in the second embodiment are the same as those in the first embodiment.

More specifically, the size of an aperture 112a in a region X11 is relatively small, the size of an aperture 112b in a region X12 is medium, and the size of an aperture 112c in a region X13 is relatively large. The aperture ratios in the regions X11 to X13 are the same. In this case, a distance between the apertures varies among the regions X11 to X13. More specifically, the distance between the apertures is relatively short in the region X11, medium in the region X12, and relatively long in the region X13. When the mask M1b with this configuration is used, it is possible to obtain the same advantageous effects as those obtained in the first embodiment.

When the MEA 90b (shown in FIG. 9B) is manufactured using the cathode-side catalyst layer 72 formed using the mask M1b, the distance between the catalyst protruding portions 71a varies depending on the region in the cathode-side catalyst layer 72. More specifically, the distance between the catalyst protruding portions 71a is relatively short in the region Y11 close to the gas supply holes 45, medium in the region Y12, and relatively long in the region Y13. In the region Y13, because the distance between the catalyst protruding portions 71a is relatively long, air and the produced water easily flow between the catalyst protruding portions 71a. Thus, it is possible to increase the water-discharge performance in the region close to the gas discharge holes 46, thereby suppressing occurrence of flooding.

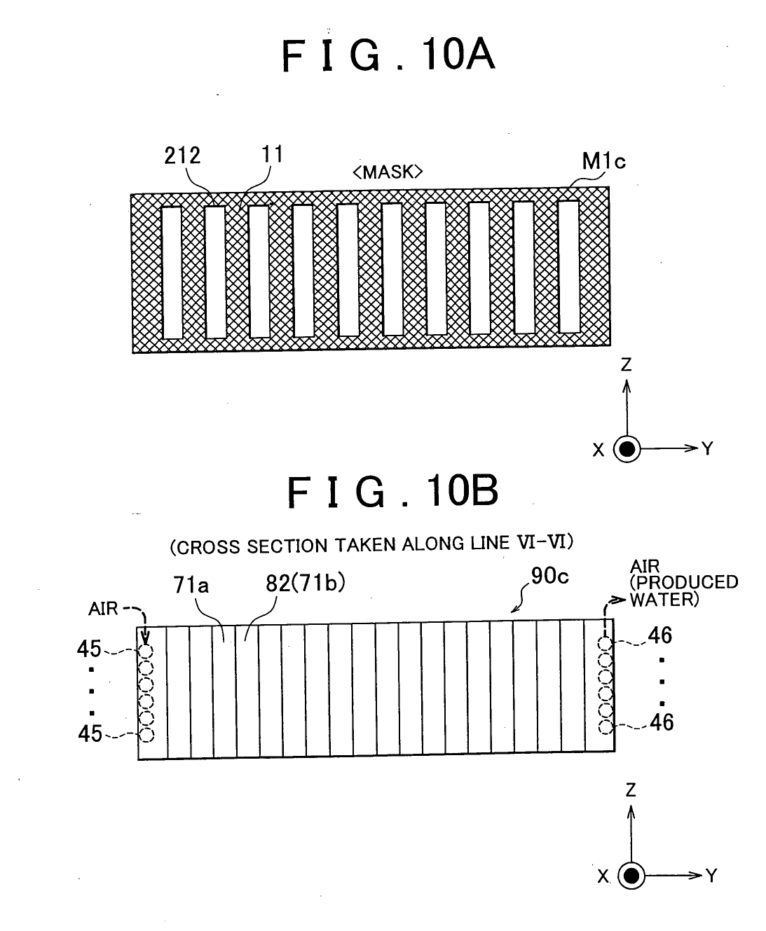

A fourth embodiment will be described. FIG. 10A shows a mask M1c in the fourth embodiment. FIG. 10B schematically shows a MEA 90c configured using the mask M1c shown in FIG. 10A. FIG. 10B shows a cross section of the MEA 90c when used to form the fuel cell, taken along the line VI-VI (refer to FIG. 6), like FIG. 7. The mask M1c in the fourth embodiment differs from the mask M1a in the first embodiment in that each aperture is rectangular. The mask M1c in the fourth embodiment differs from the mask M1a in the first embodiment also in that, in the MEA 90c produced using the mask M1c, the gas diffusion layer does not continuously extend in the cross section taken at the position near the border between the catalyst layer and the gas diffusion layer. Other portions of the configuration in the second embodiment are the same as those in the first embodiment.

More specifically, apertures 212 of the mask M1c are rectangular, and disposed at predetermined intervals in a Y-direction. When the mask M1c with this configuration is used, it is possible to obtain the same advantageous effects as those obtained in the above-described embodiments and examples.

When the MEA 90c (shown in FIG. 10B) is manufactured using the cathode-side catalyst layer 72 formed using the mask M1c, the catalyst protruding portions 71a and the catalyst recessed portions 71b are alternately disposed in the Y-direction, in the cathode-side catalyst layer 72. When the length of the aperture 212 in the Z-direction is longer than the length of the electrolyte membrane 60 in the Z-direction, the catalyst recessed portion 71b does not continuously extend from the position corresponding to the gas supply holes 45 to the position corresponding to the gas discharge holes 46, unlike the first embodiment. Accordingly, the cathode-side gas diffusion layer 82 does not continuously extend from the position corresponding to the gas supply holes 45 to the position corresponding to the gas discharge holes 46.

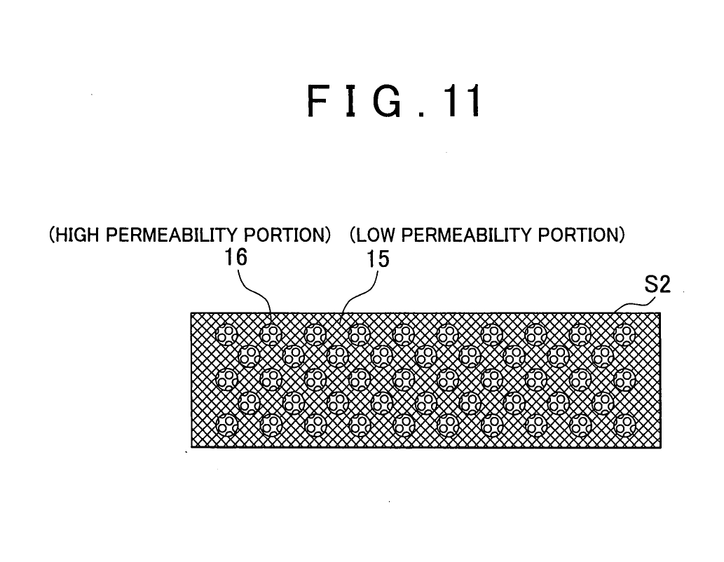

A fifth embodiment will be described. FIG. 11 shows a screen in the fifth embodiment. The fifth embodiment differs from the first embodiment in the permeability is not uniform in a screen; and the catalyst powder is deposited without using the mask M1 in step S110 (shown in the flowchart in FIG. 1). Other portions of the configuration in the fifth embodiment are the same as those in the first embodiment.

More specifically, a screen S2 in the fifth embodiment includes a low permeability portion 15 with a relatively low permeability, and high permeability portions 16 with a relatively high permeability. The high permeability portions 16 are disposed at positions corresponding to the positions of the apertures 12 in the mask M1 (FIG. 3B). The low permeability portion 15 is disposed at a position corresponding to the position of the masking portion 11 in the mask M1. Using the screen S2 with this configuration, it is possible to deposit the catalyst power on the electrolyte membrane 60 without using the mask M1 in step S110 (in the flowchart in FIG. 1). That is, when the catalyst powder 300 is dropped on the electrolyte membrane 60 through the screen S2, the amount of the catalyst powder dropped through a unit area of the low permeability portion 15 is smaller than the amount of the catalyst powder dropped through the unit area of the high permeability portion 16. Therefore, it is possible to form the uneven catalyst layer, as shown in FIG. 4B. The screen S2 may be regarded as the screen according to the invention.

An example in which the first embodiment of the invention was applied will be described. The MEA 90 was manufactured according to the procedure shown in FIG. 1, and a fuel cell 700 was manufactured using the MEA 90. In step S105 (in the flowchart in FIG. 1), the platinum-supported carbon (platinum 50 Wt %) and Nafion (registered trademark) that functions as the electrolyte were added to the mixed solvent of water and ethanol in a mixing container 400 (shown in FIG. 2), and the solution obtained by adding the platinum-supported carbon and Nafion to the mixed solvent was stirred to produce the catalyst slurry 200. In this process, the materials were mixed so as to produce the catalyst slurry 200 with the following composition: the platinum-supported carbon 4.0 Wt %; the electrolyte 2.0 Wt %; water 47.0 Wt %; and ethanol 47.0 Wt %. Then, the catalyst slurry 200 (shown in FIG. 2) was sprayed and dried according to the following spraying conditions so as to produce the catalyst layer powder 300: a spray pressure was 0.1 Mpa (the spray pressure signifies the pressure used when the catalyst slurry 200 is sprayed from the atomizer 414 into the chamber 412); a spray temperature (at an air inlet) was 80° C. (the spray temperature (at the air inlet) signifies the temperature of the dry air used for drying the sprayed catalyst slurry 200, when the dry air is supplied into the chamber 412); the flow rate of the dry air was 0.5 m³/min; and the flow rate of the catalyst slurry 200 supplied to the atomizer 414 was 10 ml/min. The particle diameter of the catalyst powder 300 thus produced was approximately 2 to 3 μm.

In step S110 (in the flowchart in FIG. 1), first, the catalyst powder 300 was deposited using the screen S1 so that the platinum content was 0.40 mg/cm². Next, the catalyst powder 300 was deposited so that the platinum content at the catalyst protruding portion 71a was 0.60 mg/cm², by dropping the catalyst powder 300 through the screen S1 and the mask M1. The size of the catalyst protruding portion 71a (i.e., the area of the catalyst protruding portion 71a at a half of the height of the catalyst protruding portion 71a from the layer 72a) was approximately 1000 μm². The thickness of the catalyst protruding portion 71a (i.e., the height of the catalyst protruding portion 71a from the electrolyte membrane 60) was approximately 15 μm. The thickness of the catalyst recessed portion 71b was approximately 10 μm.

In step S115 (in the flowchart in FIG. 1), hot pressing was performed using a roll press machine according to the following conditions so as to form the MEA 90: the temperature was 130° C.; the pressure was 30 kgf/cm²; and the speed at which a roll was moved was 10 m/min.

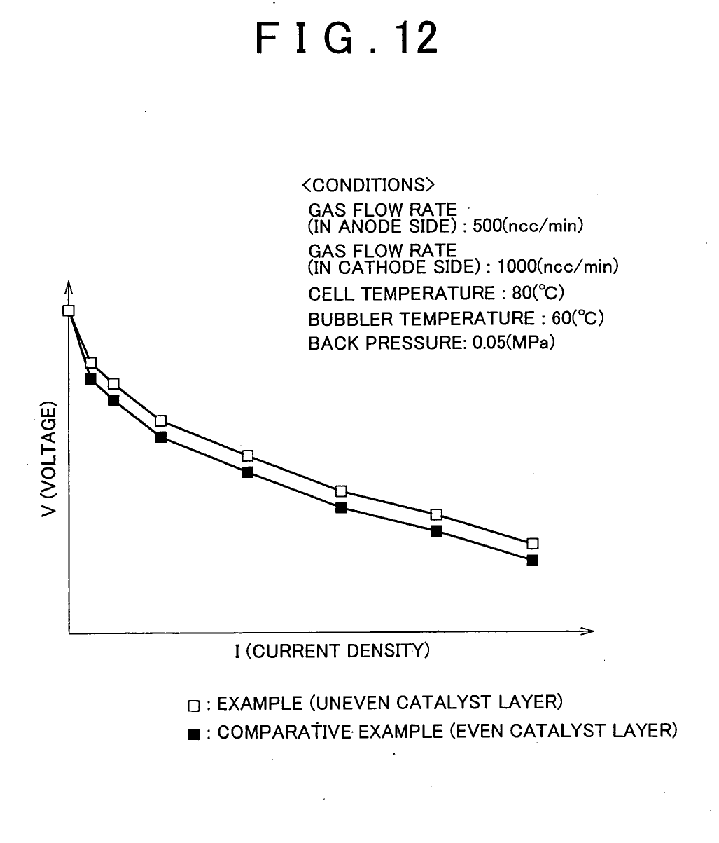

FIG. 12 is a chart showing the I-V characteristics (“I” stands for current density, and “V” stands for voltage) of the fuel cell 700 produced in an example and the I-V characteristics of a fuel cell produced in a comparative example. In the fuel cell (not shown) in the comparative example, the shape of the catalyst layer and the shape of the gas diffusion layer were different from those in the fuel cell 700 in the example. Other portions of the configuration of the fuel cell in the comparative example were the same as those of the configuration of the fuel cell in the example. More specifically, in the fuel cell in the comparative example, each of the anode-side catalyst layer and the cathode-side catalyst layer had a uniform thickness. Accordingly, the anode-side gas diffusion layer had a uniform thickness from a surface of the anode-side gas diffusion layer, which was in contact with the anode-side catalyst layer, to an opposite surface. The cathode-side gas diffusion layer had a uniform thickness from a surface of the cathode-side gas diffusion layer, which was in contact with the cathode-side catalyst layer, to an opposite surface. The weight of the catalyst (platinum) contained in the catalyst layer in the comparative example was the same as that in the example. In the actual fuel cell 700, a plurality of the MEA plates 50 and a plurality of the separators 40 are stacked. However, in each of the example and the comparative example, the I-V characteristics were obtained using the fuel cell (single cell) in which the MEA plate 50 was disposed between the two separators 40.

In the case shown in FIG. 12, the I-V characteristics were obtained by operating the fuel cells manufactured in the example and the comparative example, under the following conditions: the flow rate of fuel gas (hydrogen gas) in the anode side was 500 ncc/min; the flow rate of oxidation gas (air) in the cathode side was 1000 ncc/min; a cell temperature was 80° C.; a bubbler temperature was 60° C. in each of the anode side and the cathode side; and a back pressure was 0.05 Mpa in each of the anode side and the cathode side. As shown in FIG. 12, at the same current density, the voltage value of the fuel cell 700 in the example was higher than the voltage value of the fuel cell in the comparative example. The result shows that the fuel cell 700 in the example has higher power generation performance than that of the fuel cell in the comparative example. It is considered that the result was obtained for the following reasons. Because the uneven catalyst layer was formed, the area where the catalyst layer contacts the gas diffusion layer was increased. Also, in addition to forming the uneven catalyst layer, the gas diffusion layer was formed to continuously extend from the position corresponding to the gas supply holes to the position corresponding to the gas discharge holes in the cross section of the MEA 90 taken at the position near the border between the catalyst layer and the gas diffusion layer. Thus, the reaction gas was diffused in the entire MEA 90.

It is to be understood that the invention is not limited to the described example and the embodiments, and the invention may be embodied in various manners within the scope of the invention. For example, the modifications as described below are included within the scope of the invention.

A modified example 1 will be described. In each of the above-described embodiments, the cathode-side catalyst layer 72 is formed by depositing the catalyst powder 300 on the electrolyte membrane 60. Instead, the cathode-side catalyst layer 72 may be formed by depositing the catalyst powder 300 on the cathode-side gas diffusion layer 82. Also, the cathode-side catalyst layers 72 may be formed by depositing the catalyst powder 300 on the electrolyte membrane 60, and on the cathode-side gas diffusion layer 82, and then performing hot pressing. The anode-side catalyst layer(s) may be formed in the same manners. That is, in the MEA manufacturing method according to the invention, it is possible to employ a process in which the catalyst layer is formed by depositing the catalyst powder on at least one of the electrolyte membrane and the gas diffusion layer.

A modified example 2 will be described. In each of the above-described embodiments, the catalyst powder 300 is deposited on the electrolyte membrane 60 by electrostatic screening. However, instead of this, any other deposition method may be employed. For example, the catalyst powder 300 may be deposited using a spray method in which the catalyst powder 300 is sprayed on electrolyte membrane 60 by a spray. Alternatively, the catalyst powder 300 may be deposited on the electrolyte membrane 60 using an electrophotographic method. In the electrophotographic method, the electrically charged catalyst powder 300 is electrostatically attached to a photoconductor drum that is electrically charged in a predetermined pattern, and the catalyst powder 300 attached on the photoconductor drum is transferred to the electrolyte membrane 60. In other words, generally, any deposition method may be used as a part of the MEA manufacturing method according to the invention, as long as the catalyst powder 300 is deposited on the electrolyte membrane 60.

While the invention has been described with reference to example embodiments thereof, it is to be understood that the invention is not limited to the described embodiments or constructions. On the other hand, the invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A method of manufacturing a membrane electrode assembly for a fuel cell, in which a catalyst layer is disposed between an electrolyte membrane and a gas diffusion layer, the method comprising:
producing a catalyst powder that is used to form the catalyst layer; and
forming the catalyst layer by unevenly depositing the catalyst powder on at least one of the electrolyte membrane and the gas diffusion layer.

2. The method according to claim 1, wherein:
the fuel cell includes a gas supply hole through which reaction gas supplied to the fuel cell is supplied to the catalyst layer via the gas diffusion layer, and a gas discharge hole through which the reaction gas discharged from the catalyst layer is discharged via the gas diffusion layer;
the catalyst layer is formed so that a proportion of a recessed portion in a unit area in a gas discharge-side region of the catalyst layer close to the gas discharge hole is larger than that in a gas supply-side region of the catalyst layer close to the gas supply hole, in a plane view of the catalyst layer perpendicular to a deposition direction in which the catalyst powder is deposited; and
a deposition amount of the catalyst powder in the recessed portion is smaller than an average deposition amount of the catalyst powder in the catalyst layer.

3. The method according to claim 1, wherein:
the catalyst layer is formed by depositing the catalyst powder so that a recessed portion of the catalyst layer continuously extends from a position corresponding to a gas supply hole through which reaction gas supplied to the fuel cell is supplied to the catalyst layer via the gas diffusion layer, to a position corresponding to a gas discharge hole through which the reaction gas discharged from the catalyst layer is discharged via the gas diffusion layer; and
a deposition amount of the catalyst powder in the recessed portion is smaller than an average deposition amount of the catalyst powder in the catalyst layer.

4. The method according to claim 1, wherein:
the catalyst layer is formed by depositing the catalyst powder using a screen through which the catalyst powder passes;
the screen includes a powder-passing area through which the catalyst powder passes, and the powder-passing area includes a high permeability portion that has a predetermined permeability, and a low permeability portion that has a permeability lower than the permeability of the high permeability portion;
a recessed portion of the catalyst layer is formed by the catalyst powder that has passed through the low permeability portion; and
a deposition amount of the catalyst powder in the recessed portion is smaller than an average deposition amount of the catalyst powder in the catalyst layer.

5. The method according to claim 2, wherein:
the catalyst layer is formed using a mask that includes a plurality of apertures through which the catalyst powder passes;
the apertures are disposed in a manner such that an aperture ratio decreases from one end of the mask to another end of the mask;
the one end of the mask is disposed above a gas supply-side region of at least one of the electrolyte membrane and the gas diffusion layer, and the gas supply-side region is to be positioned close to the gas supply hole;
the other end of the mask is disposed above a gas discharge-side region of the at least one of the electrolyte membrane and the gas diffusion layer, and the gas discharge-side region is to be positioned close to the gas discharge hole;
protruding portions of the catalyst layer are formed by the catalyst powder that has passed through the apertures; and
a deposition amount of the catalyst powder in each of the protruding portions is equal to or larger than an average deposition amount of the catalyst powder in the catalyst layer.

6. The method according to claim 1, wherein:
the fuel cell includes a gas supply hole through which reaction gas supplied to the fuel cell is supplied to the catalyst layer via the gas diffusion layer, and a gas discharge hole through which the reaction gas discharged from the catalyst layer is discharged via the gas diffusion layer;
the catalyst layer is formed so that a proportion of a recessed portion in a unit area is uniform in the entire catalyst layer, and a distance between protruding portions adjacent to each other in a gas discharge-side region of the catalyst layer close to the gas discharge hole is longer than that in a gas supply-side region of the catalyst layer close to the gas supply hole, in a plane view of the catalyst layer perpendicular to a deposition direction in which the catalyst powder is deposited; and
a deposition amount of the catalyst powder in the recessed portion is smaller than an average deposition amount of the catalyst powder in the catalyst layer, and the deposition amount of the catalyst powder in each of the protruding portions is equal to or larger than the average deposition amount.

7. The method according to claim 6, wherein:
the catalyst layer is formed using a mask that has a plurality of apertures through which the catalyst powder passes;
the apertures are disposed in a manner such that an aperture ratio is uniform in the entire mask, and a distance between the apertures adjacent to each other increases from one end of the mask to another end of the mask;
the one end of the mask is disposed above a gas supply-side region of at least one of the electrolyte membrane and the gas diffusion layer, and the gas supply-side region is to be positioned close to the gas supply hole;
the other end of the mask is disposed above a gas discharge-side region of the at least one of the electrolyte membrane and the gas diffusion layer, and the gas discharge-side region is to be positioned close to the gas discharge hole;
protruding portions of the catalyst layer are formed by the catalyst powder that has passed through the apertures; and
a deposition amount of the catalyst powder in each of the protruding portions is equal to or larger than an average deposition amount of the catalyst powder in the catalyst layer.
